(19) United States
(12) Patent Application Publication
(10) Pub. No.: US 2005/0069186 A1
(43) Pub. Date: Mar. 31, 2005

(54) Medical image processing apparatus

(75) Inventor: Tsuyoshi Kobayashi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA MEICAL & GRAPHIC, INC.

(21) Appl. No.: 10/948,543

(22) Filed: Sep. 24, 2004

(30) Foreign Application Priority Data
Sep. 30, 2003 (JP) 2003-339353

(51) Int. Cl. G06K 9/00

(52) U.S. Cl. 382/128; 382/162

(57) ABSTRACT

A medical image processing apparatus includes: a target region detecting section for detecting an exposure field part in a medical image generated from a subject,.and for dividing the exposure field part into a target region and a non-target region; a gradation converting section for performing a different gradation converting process on each of the target region and the non-target region; and an outputting section for outputting the medical image on which the gradation process is performed to an image outputting apparatus.

### BACKGROUND OF THE INVENTION

1. Field of the Invention

The invention relates to a medical image processing apparatus which processes a medical image generated from a subject.

2. Description of Related Art

So far, in a medical field, while medical image data generated by a medical image generating apparatus, such as an X-ray radiographing apparatus which uses radiations such as X rays or the like, a CR (Computed Radiography) apparatus, a CT (Computed Tomography) apparatus, an MRI (Magnetic Resonance Imaging) apparatus or the like, is displayed on an image displaying device, diagnosis is performed so that a doctor interprets the medical image displayed on this image displaying device and observes a state of a lesion or a course of the same with time.

Further, for the purpose of reducing burdens on doctor's interpretation, what has been developed is Computer-Aided Diagnosis (CAD), which analyses image data with the use of the digital image processing technology and provides a suitable image for the diagnosis.

For example, what is proposed is an image processing method for recognizing a subject position in a radiation image, for determining an interest region based on the recognition result, and for performing an image processing based on image information within the interest region (for example, see JP-Tokukai-2001-222704A). With this method, it is possible to perform the image processing under an image processing condition which is suitable for a target region of the diagnosis.

However, in earlier arts, since the image processing is performed under the same condition on both a target region of the diagnosis and a non-target region, the following problem occurs. For example, in a non-target region, unevenness is caused by the heel effect which occurs at the time of X-ray radiographing, film distortion, grid mesh or the like. Such unevenness is unnecessary while a medical image is being interpreted, and it becomes an obstacle against doctor's diagnosis. Further, as shown in FIG. 3, there is an image which is generated with a lead marker inserted, the lead marker on which a distinction of left mamma or right mamma and a generating state are written. Lead has so high X-ray absorbability that X rays cannot pass through. Accordingly, as shown in FIG. 3, a marker part 15 on which the lead marker is generated appears clear (transparent, having low density). Therefore, when an image is outputted on a film (hardcopy) to be interpreted over a Schaukasten, light leaks through the marker part 15, and thereby it is difficult to interpret the image.

### SUMMARY OF THE INVENTION

The present invention was made in consideration of the problems in the above-mentioned earlier art, and an object thereof is to provide a medical image processing apparatus which generates an image which is easy for a doctor to do the interpretation.

In order to solve the foregoing problem, in accordance with a first aspect of the present invention, a medical image processing apparatus comprises: a target region detecting section for detecting an exposure field part in a medical image generated from a subject, and for dividing the exposure field part into a target region and a non-target region; a gradation converting section for performing a different gradation converting process on each of the target region and the non-target region; and an outputting section for outputting the medical image on which the gradation process is performed to an image outputting apparatus.

According to the apparatus of the first aspect, the exposure field part of a medical image is divided into a target region and a non-target region, and a different gradation converting process is respectively applied on each region. Therefore, it is possible to generate an image which is easy for a doctor to interpret.

Preferably, the medical image comprises a radiography.

According to the above-mentioned apparatus, the exposure field part of an X-ray simple radiography is divided into a target region and a non-target region, and a different gradation converting process is respectively applied on each region. Therefore, it is possible to generate an image which is easy for a doctor to interpret.

Preferably, the target region comprises a mamma region.

According to the above-mentioned apparatus, the exposure field part of a medical image is divided into a mamma region and a non-mamma region, and a different gradation converting process is respectively performed on each region. Therefore, it is possible to generate an image which is easy for a doctor to interpret.

Preferably, the gradation converting section performs the gradation converting process for increasing a gradient of a middle density part in the target region to be larger than a gradient of a low density part and a high density part in the target region, or for increasing a gradient of a middle brightness part in the target region to be higher than a gradient of a high brightness part and a low brightness part in the target region.

According to the above-mentioned apparatus, a gradation converting process which increases gradient of middle density of middle brightness to be larger than that of low density or high brightness, and that of high density or low brightness, on the target region. Therefore, it is possible to improve gradation characteristic in an middle density part or in an middle brightness part.

Preferably, the gradation converting section converts a density of the non-target region into one density or converts a brightness of the non-target region into one brightness.

According to the above-mentioned apparatus, since density or brightness in the non-target region is converted into single density or single brightness, it is possible to reduce unevenness in the non-target region. Therefore, the recognition of the non-target region becomes easier, and thereby it is possible to generate an image which is easy for a doctor to interpret.

Preferably, the gradation converting section converts a gradation of the non-target region so as to form two density regions or two brightness regions by using any threshold.

According to the above-mentioned apparatus, the non-target region is divided according to an optional threshold so as to form two density regions or two brightness regions. Therefore, it is possible to reduce unevenness in the non-target region, and further it is possible to express the difference of density or brightness which should be distinguished. Consequently, the recognition of the non-target region becomes easier, and thereby it is possible to generate an image which is easy for a doctor to interpret.

Preferably, the gradation converting section converts a gradient of the non-target region so as to make a density of a low density part higher or so as to make a brightness of a high brightness part lower.

According to the above-mentioned apparatus, density of a low density part of the non-target region is converted to be higher or brightness of a high brightness part of the non-target region is converted to be lower. Therefore, it is possible to suppress the brightness of a low density part or a high brightness part. Consequently, it is possible to prevent the decrease of interpretation accuracy and efficiency due to the low density part or the high brightness part being too bright.

Preferably, the gradation converting section converts a density of an area other than the exposure field part in the medical image, into one density which is higher than a density of the non-target region, or converts a brightness of the area into one brightness which is lower than a density of the non-target region.

According to the above-mentioned apparatus, density or brightness of an area other than the exposure field part in a medical image is converted into single density which is higher than the density of the non-target region or single brightness which is lower than the brightness of the non-target region. Therefore, it is possible to reduce unevenness in the area other than the exposure field part, and thereby it is possible to generate an image which is easy for a doctor to interpret.

Preferably, the apparatus of the first aspect further comprises: a gradation conversion curve storing section for storing a plurality of gradation conversion curves; and a gradation conversion curve selecting section for selecting a gradation conversion curve among the plurality of gradation conversion curves, to perform the gradation converting process corresponding to an output purpose, wherein the gradation converting section performs the gradation converting process according to the selected gradation conversion curve.

According to the above-mentioned apparatus, by selecting a gradation converting curve to be used for performing a gradation converting process corresponding to an output purpose among the plurality of gradation conversion curves, it is possible to perform the gradation converting process corresponding to the output purpose.

Preferably, the apparatus of the first aspect further comprises a gradation converting process condition changing section for changing a condition of the gradation converting process, wherein the gradation converting section performs the gradation converting process under the changed condition of the gradation converting process.

According to the above-mentioned apparatus, with a condition of the gradation converting process changed, it is possible to perform the gradation converting process according to the changed gradation converting process condition.

Here, in an image outputting apparatus which outputs a medical image on a film or paper, density being high indicates being black, and density being low indicates being white. Further, on an image outputting apparatus such as an LCD (Liquid Crystal Display), a CRT or the like, brightness being high indicates being white, and brightness being low indicates being black. Preferably, according to an image outputting apparatus which outputs a medical image after the gradation converting process, a suitable process is performed.

The present invention is in particular effective when a high-brightness Schaukasten or a high-brightness monitor. For example, it is effective for the interpretation on a mamma image, which requires a Schaukasten having higher brightness than the case of interpreting a generated image in general.

### BRIEF DESCRIPTION OF THE DRAWINGS

The present invention will become more fully understood from the detailed description given hereinafter and the accompanying drawing given by way of illustration only, and thus are not intended as a definition of the limits of the present invention, and wherein:

FIG. 1 is a block diagram showing a functional structure of a medical image processing apparatus 1 of an embodiment according to the present invention,

FIG. 2 is a flowchart illustrating an interpretation image outputting process performed by the medical image processing apparatus 1,

FIG. 3 is a view for describing an exposure field part, a mamma region and a non-mamma region in a mamma image,

FIG. 4 is a flowchart illustrating a gradation converting process,

FIG. 5A is a view showing an example of a gradation conversion curve to be used in a gradation converting process which makes gradient of middle density more than that of low density or high density, FIG. 5B is a view showing a gradation conversion curve to be used in a gradation converting process which makes density of low density part higher, FIG. 5C is a view showing an example of gradation conversion line to be used in a gradation converting process which converts the density into one density, FIG. 5D is a view showing an example of a gradation conversion line to be used in a gradation converting process which converts input signal values into two output signal values according to a predetermined threshold so as to form two density regions in the non-mamma region,

FIG. 6A is a view showing an example of a reversal process, FIG. 6B is a view showing an example of a magnification emphasizing process which emphasizes gradation only within a predetermined range among the input signal values, and FIG. 6C is a view showing an example of a gradation converting process which eliminates only middle density components among the input signals.

### PREFERRED EMBODIMENTS OF THE INVENTION

Hereinafter, with reference to figures, an embodiment of the present invention will be described in detail.

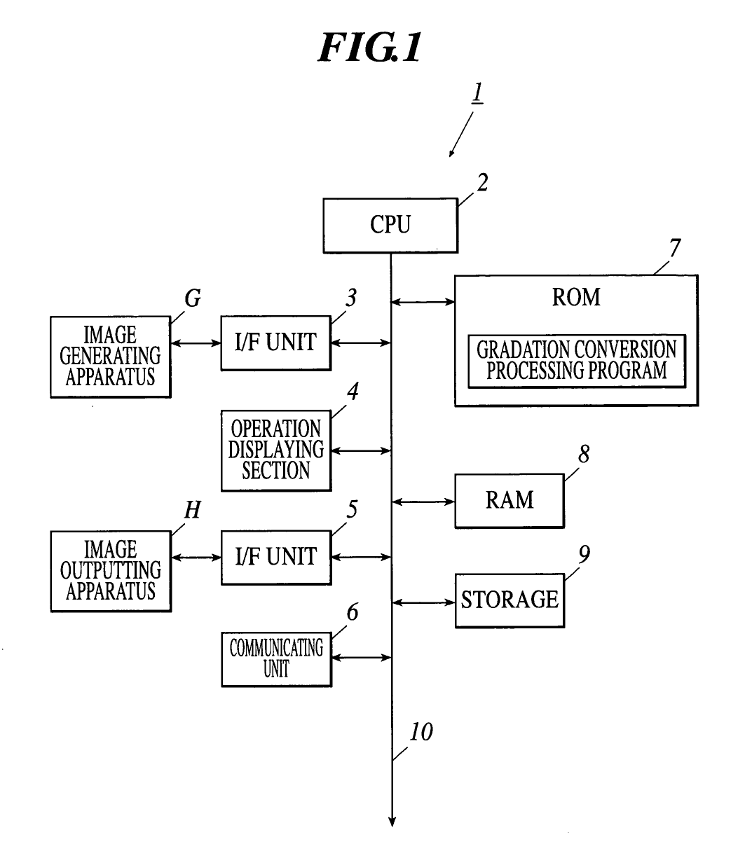

FIG. 1 shows a functional structure of a medical image processing apparatus 1 in the present embodiment.

As shown in FIG. 1, the medical image processing apparatus 1 comprises a CPU (Central Processing Unit) 2, an I/F (InterFace) unit 3, an operation displaying section 4, an I/F unit 5, a communicating unit 6, a ROM (Read Only Memory) 7, a RAM (Random Access Memory) 8, a storage 9 and the like. Each unit is connected by a bus 10.

The CPU 2 develops into a work area of the RAM 8, a program designated among various types of programs stored in the ROM 7 according to data inputted from the I/F unit 3 or the communicating unit 6. Further, the CPU 2 performs various processes in conjunction with the above-mentioned programs, and displays the processing result on the operation displaying section 4, as well as stores the processing result in a predetermined area of the RAM 8.

The I/F unit 3 is an interface for establishing a. connection to an image generating apparatus G, and inputs medical image data such as a radiography or the like to the medical image processing apparatus 1. Here, the radiography is a two-dimensional photography generated with X rays.

As the image generating apparatus G, for example, it is possible to apply a laser digitizer which obtains medical image data by scanning laser light over a film in which a medical image is recorded, a film scanner which obtains medical image data recorded in a film with a sensor comprising photoelectric transducers such as CCD (Charge Coupled Device), and the like.

Further, the method for inputting medical image signals is not limited to reading a medical image recorded in a film. A generating apparatus which generates a medical image with the use of accumulative phosphor, a flat panel detector comprising a radiation detecting device which generates electric charge corresponding to irradiated radiation and a condenser, and the like may be structured as connectable to be used for the method. After all, a method for inputting medical image data is not specifically limited.

The operation displaying section 4 comprises an LCD (Liquid Crystal Display), and displays on a display screen, various operation buttons, a state of the apparatus, a preview of a medical image which is to be outputted to an image outputting apparatus H, and the like. The display screen of LCD is covered with a touch panel that is a pressure-sensitive type (resistance film pressure type) structured so as to arrange transparent electrodes in a mesh fashion. Thereby, the touch panel detects as a voltage value, an X-Y coordinate of a power point on which a finger, a touch pen or the like is pressed, and outputs the detected position signal to the CPU 2 as an operation signal. Here, the displaying device and the inputting device may be provided separately. As the displaying device, a CRT, a liquid crystal display, a plasma display or the like can be used. As the inputting device, a keyboard comprising function keys corresponding to various types of functions such as cursor keys, numeric keys, a determining key and the like, and a pointing device such as a mouse or the like can be used.

The I/F unit 5 is an interface for establishing a connection to the image outputting apparatus H. Also, the I/F unit 5 is the outputting section for outputting medical image data on which the medical image processing apparatus 1 applies the image processing to the image outputting apparatus H.

As the image outputting apparatus H, it is possible to apply a film outputting apparatus which outputs medical image data on a film, a printing apparatus which prints medical image data on various types of paper, a displaying apparatus which displays medical image data on a display screen such as an LCD, a CRT, or the like. In the present embodiment, what will be described is the case that a film outputting apparatus is connected as the image outputting apparatus H. The film outputting apparatus comprises an exposing unit for doing the exposure by irradiating laser beam over a film having a surface on which exposing agent is formed, and a developing unit for developing the film after the exposure. Thereby, it outputs image data on a film.

The communicating unit 6 comprises a communications interface such as a network interface card, a modem, a terminal adaptor or the like, and transmits/receives various types of data to/from an external device on a communication network. For example, it is possible to built a structure in which medical image data is received from the image generating apparatus G through the communicating unit 6, or a structure in which medical image data on which image processing is applied is transmitted through the communicating unit 5 by establishing a connection to a server within a hospital or diagnosis terminals located in each diagnostic room.

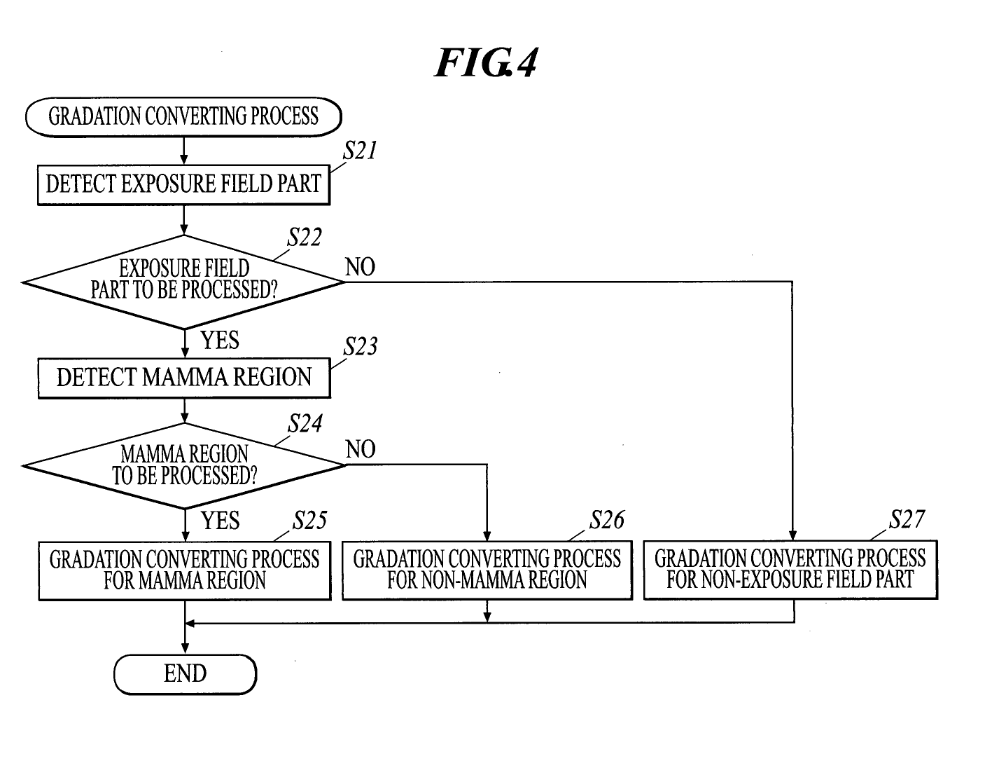

The ROM 7 comprises a nonvolatile semiconductor memory, and stores various types of programs executed by the CPU 2, or the like. In the ROM 7, stored is a gradation conversion processing program (see FIG. 4). According to the combination of this program and the CPU 2, it is possible to realize the target region detecting section and the gradation converting section.

The RAM 8 comprises a rewritable semiconductor device. The RAM 8 is a storage medium in which data is temporarily stored. The RAM 8 forms a program area for developing a program to be executed by the CPU 2, a data area for storing various types of processing results or the like by the CPU 2, and so forth.

The storage 9 stores image data inputted from the image generating apparatus G through the I/F unit 3, image data received by the communicating unit 6, image data on which image processing including the gradation converting process is applied, and the like. Further, the storage 9 has a function as the gradation conversion curve storing section which stores a plurality of gradation conversion curves to be used in the gradation converting process.

Next, an operation in the present embodiment will be described.

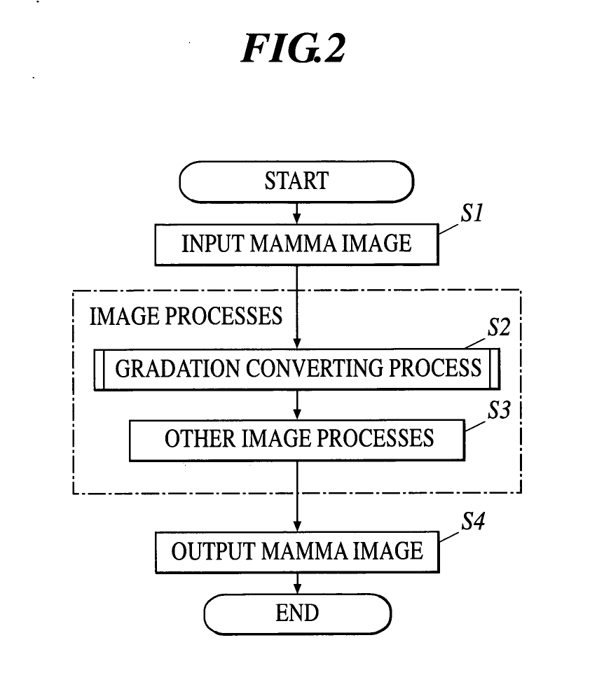

FIG. 2 is a flowchart illustrating an interpretation image outputting process performed by the medical image processing apparatus 1.

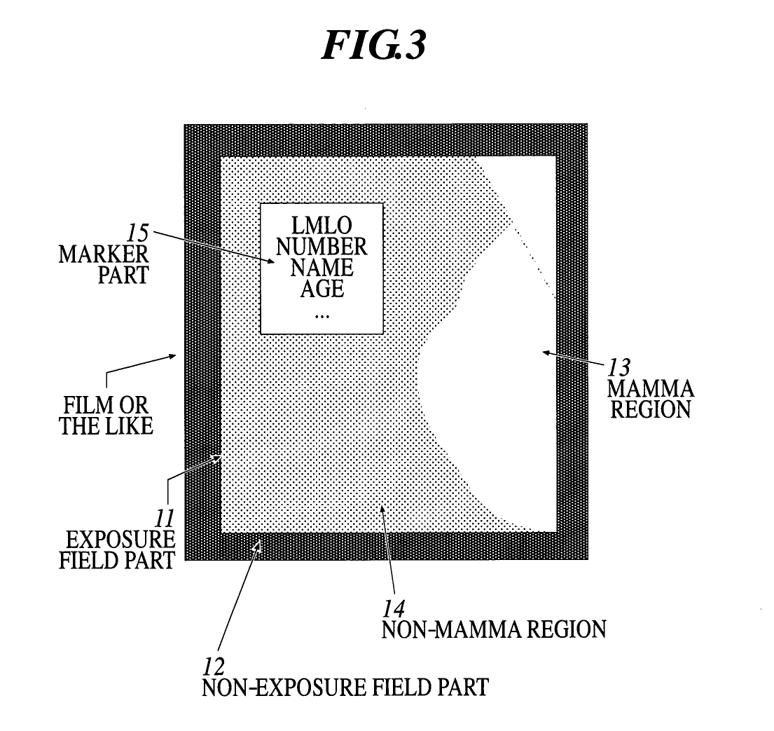

As shown in FIG. 2, at first, image data obtained from a mamma of a patient is inputted through the I/F unit 3 or the communicating unit 6 (Step S1), and the image data is stored in the storage 9. For the time of generating an X-ray image, an exposure field aperture is attached to an X-ray generating device so as to irradiate X rays only in a direction toward the subject. Therefore, in an X-ray image, as shown in FIG. 3, an exposure field part 11 and a non-exposure field part 12 exist. Further, the exposure field part 11 is divided into a target region (a mamma region 13 in FIG. 3) and a non-target region (a non-mamma region 14 in FIG. 3). At the time of generating an image, in the non-target area, a marker which indicates a region to be generated, a generating direction, a patient name or the like are generally put. Therefore, as shown in FIG. 3, the marker part 15 having low density exists in the image.

Next, the gradation converting process is applied on the image data (Step S2).

FIG. 4 is a flowchart illustrating the gradation converting process.

As shown in FIG. 4, the exposure field part 11 is detected from image data (Step S21). For example, according to the exposure field recognizing method as disclosed in JP-Tokukaihei-4-242636A, based on a difference between a pixel value (signal value) in a region to which X rays are irradiated and a pixel value in a region to which X rays are blocked by the exposure field aperture from being irradiated, the image is divided according to a predetermined threshold, and thereby the exposure field part 11 is recognized.

Then, a mamma region 13 is detected in the exposure field part 11 (Step S22; YES), and therefore the image is divided into the mamma region 13 and the other, which is a non-mamma region 14 (Step S23). For example, a threshold for classifying pixel values into a pixel value of the non-mamma region 14 to which X rays are directly irradiated, and a pixel value of the mamma area 13 to which X rays are irradiated through a subject (mamma), is in advance set with respect to a medical image in which a region to be generated is already recognized. Then, the mamma region 13 and the non-mamma region 14 are recognized according to this threshold. This type of the subject recognizing process is disclosed in a document “Mammogram CAD System” (by Motohiro Kato, Hiroshi Fujita, Takeshi Hara and Tokiko Endo), Journal of Japan Society of Medical Imaging and Information Sciences 14, p.104-113, 1997, in JP-Tokukaihei-3-218578, and in Journal of Japan Association of Breast Cancer Screening 14, No 1, pp87-102, 1998.

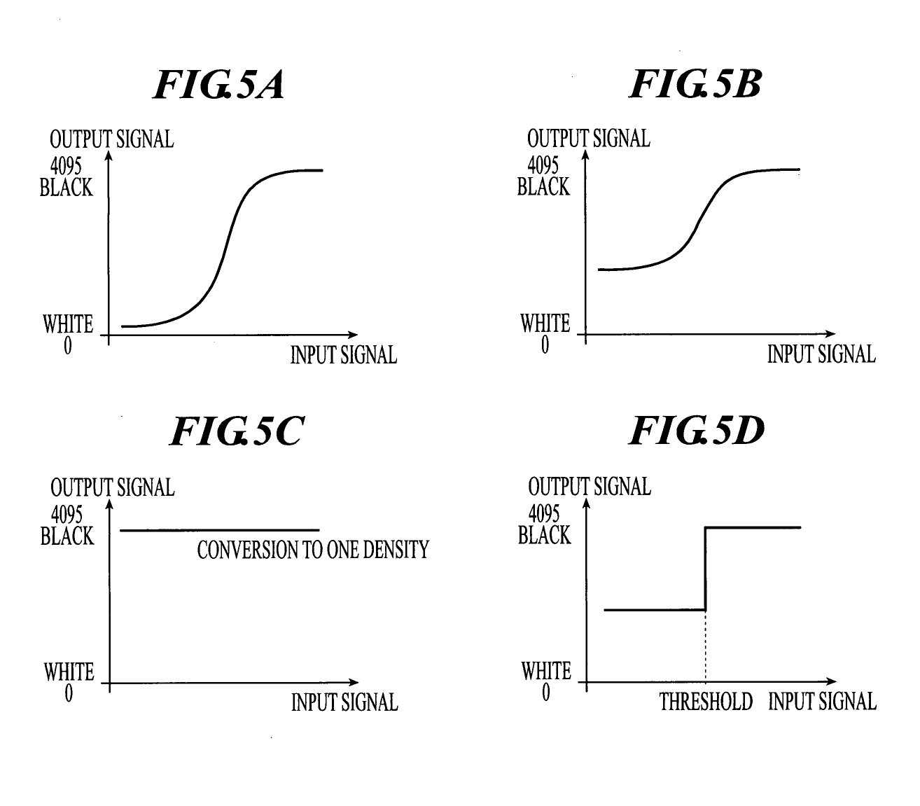

On the mamma region 13 (Step S24; YES), applied is a gradation converting process which increases a gradient of middle density as shown in FIG. 5A relatively with respect to that of low density or that of high density (Step S25). Here, the gradient is an inclination which indicates a relation between input and output in the gradation converting process in a coordinate structured by the input signal value as the horizontal axis and the output signal value as the vertical axis, the relation being expressed as a curve chart (gradation conversion curve) shown in FIG. 5A. The gradation conversion shown in FIG. 5A is a conversion to output a gradation conversion curve having the shape of letter ‘S’ with respect to an input signal value, that is, a conversion for increasing gradation characteristic of a part having necessary information for interpretation on a mamma, such as mammary gland, abnormal tissue or the like (middle density part), and for decreasing gradation characteristic of a high density part and a low density part having substantially no necessary information for the interpretation, whereby it is possible to observe a medical image in which information of the middle density part is magnified to a wider density range. This is a gradation converting curve having a similar shape to a characteristic of a conversion which is conventionally used for outputting a general analog film. Here, of course, it is possible to arbitrarily set a range of the middle density part whose gradation characteristic is to be increased, and ranges of the low density part and the high density part whose gradation characteristics are to be decreased, that is, it is possible to arbitrarily set a concrete shape of the gradation converting curve of letter ‘S’. Here, a large output signal value indicates high density, and an output signal value of 0 is equivalent to white and an output signal value of 4095 is equivalent to black.

As a method for determining a gradation converting process condition, by doing the histogram analysis in a mamma region, for example, according to a method disclosed in JP-Tokukaisho-63-262141A and JP-Tokukaihei-8-62751A, a region corresponding to an important signal region in the diagnosis is determined. This is called an interest region setting, and thereby it is possible to determine an index signal value of the interest region. Then, by using this index signal value, a gradation conversion curve is set, as described in JP-Tokukaisho-59-83149A.

Meanwhile, on the non-mamma region 14 (Step S24; NO), applied is a gradation converting process for a non-mamma region (Step S26). As such gradation converting process for a non-mamma region, for example, by using the gradation conversion curve as shown in FIG. 5B, a process to make the density of a low density part higher. Thereby, it is possible to suppress the brightness of a low density part (white part) such as the marker part 15 or the like, and therefore it is possible to avoid decreasing the interpretation accuracy and efficiency due to the low density part being too bright. On the other hand, since a high density part such as letters or the like is recognizable, it is possible to provide a better interpretation environment.

Further, the gradation converting process for a non-mamma region may be a conversion to one density as shown in FIG. 5C. With this conversion, since it is possible to reduce the unevenness in the non-mamma region 14, it is possible to recognize the non-mamma region 14 more easily, and thereby it is possible to generate an image which is easy for a doctor to interpret. This one density to be converted into may be any. However, preferably, this one density is not too bright (density value from 1000 to 4095).

Further, as the gradation converting process for a non-mamma region, as shown in FIG. 5D, it is possible to convert the input signal values into two different output signal values according to a predetermined threshold so that the non-mamma region 14 is formed from two different density regions. Here, the threshold may be set to any. Thereby, it is possible to reduce the unevenness in the non-mamma region 14, and further it is possible to recognize a part which should be outputted with different density, such as the marker part 15 or the like.

The gradation converting process for a non-mamma region is not limited to the examples cited in FIGS. 5B, 5C and 5D. Various types of effective gradation conversions for improving the interpretation environment can be applied.

On the non-exposure field part 12 (Step S22; NO), applied is a gradation converting process for a non-exposure field part (Step S27). Such gradation converting process for a non-exposure field part is a process to convert the density of the non-exposure field part 12 into one density which is the same as or higher than the density of the non-mamma region 14. With this conversion, it is possible to reduce the unevenness in the non-exposure field part 12.

Preferably, the gradation converting processes which are applied on the mamma region. 13, the non-mamma region 14 and the non-exposure field part-12 are selectable according to an outputting purpose. For example, with an instruction given through the operation displaying section 4 by a doctor who interprets a medical image, it is assumed that it is possible to select a gradation conversion curve to be used in the gradation converting process on each area among a plurality of gradation conversion curves stored in the storage 9. At this time, the operation displaying section 4 has a function as the gradation conversion curve selecting section for selecting a gradation conversion curve. Then, according to the selected gradation conversion curve, the gradation converting process is performed.

Further, it is possible to build a structure in which a gradation converting process condition is changeable, for example, the gradation conversion curve stored in the storage 9 is changed or tweaked by giving an instruction through the operation displaying section 4, or the like. In this case, the operation displaying section 4 has a function as the gradation converting process condition changing section which changes a condition of the gradation converting process. Then, according to the changed condition of the gradation converting process, the gradation converting process is performed.

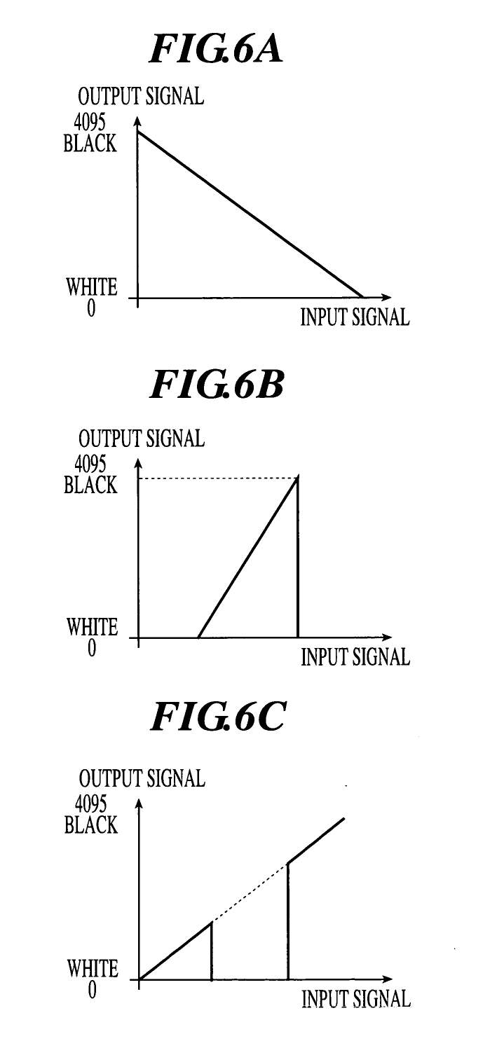

FIGS. 6A, 6B and 6C show examples of various types of gradation converting processes. By applying the reversal process as shown in FIG. 6A on the mamma region 13, it is possible to obtain an effect which makes a lesion part look distinct. Further, FIG. 6B shows an example of a magnification emphasizing process which emphasizes gradation only within a predetermined range among input signal values, and FIG. 6C shows an example of a gradation converting process which eliminates only the middle density components among input signals. By making a gradation converting process selectable so as to perform a suitable gradation converting process according to a doctor's preference, it is possible to generate an image which is easy for a doctor to interpret.

Next, as shown in FIG. 2, in order to provide a suitable and eye-friendly mamma image for diagnosis, other image processes are applied (Step S3). For example, processes such as an equalization process which compresses the dynamic range of image signals based on unsharp image signals so as to put the whole image having wide dynamic range within an eye-friendly density range, a frequency process for expressing radiographed (generated) components of a human body more shapely by controlling frequency characteristic of an image (unsharpness mask process disclosed in Japanese Utility Model Application Publication No. Jitsukosyo 62-62373, Japanese Utility Model Application Publication No. Jitsukosyo 62-62376, or the like), a frequency process according to the multi-resolution method disclosed in JP-Tokukaihei-9-44645A. Preferably, these image processes are applied only on the mamma region 13, in consideration of the processing speed. Image data on which the above-mentioned image processes have been applied is stored in the storage. 9.

Next, after the image processing is applied, the image data stored in the storage 9 is outputted to the image outputting apparatus H (Step S4). Then, the image outputting apparatus H outputs a mamma image on a film.

With the above, the interpretation image outputting process is completed.

Accordingly, according to the medical image processing apparatus 1 of the present embodiment, the exposure field part 11 of a medical image is divided into the mamma region 13 and the non-mamma region 14, and a different gradation converting process is performed on each region. Therefore, it is possible to generate an image which is easy for a doctor to interpret.

Here, the description above in the embodiment is an example of a suitable medical image processing apparatus according to the present invention, and the present invention is not limited to this description. The detailed structures and the detailed operations of the medical image processing apparatus may be suitably changed without departing the gist of the present invention.

In the embodiment above, described is the case that the medical image processing apparatus 1 is connected to the film outputting apparatus as the image outputting apparatus H. However, the present invention is not limited to this case. Image data on which the image processes has been performed may be outputted to a printing apparatus which prints the image on various types of paper, or may be outputted to a displaying apparatus which displays the medical image data on a display screen such as an LCD, a CRT or the like.

Further, in the embodiment above, described is the case that the gradation converting process converts a density component of an image. However, the present invention is not limited to this case. For example, the gradation converting process may convert a brightness component of an image.

Further, in the embodiment above, described is the case that image data in which information obtained by radiographing (or generating an image of) a mamma is stored is used as a medical image. However, a region to be a generating target by the present invention is not limited to this case. Such region may be chest or abdomen.

The entire disclosure of a Japanese Patent Application No. Tokugan 2003-339353 filed on Sep. 30, 2003, including specifications, claims, drawings and summaries are incorporated herein by reference in their entirety.

1. A medical image processing apparatus comprising:
a target region detecting section for detecting an exposure field part in a medical image generated from a subject, and for dividing the exposure field part into a target region and a non-target region;
a gradation converting section for performing a different gradation converting process on each of the target region and the non-target region; and
an outputting section for outputting the medical image on which the gradation process is performed to an image outputting apparatus.

2. The apparatus of claim 1, wherein the medical image comprises a radiography.

3. The apparatus of claim 1, wherein the target region comprises a mamma region.

4. The apparatus of claim 1, wherein the gradation converting section performs the gradation converting process for increasing a gradient of a middle density part in the target region to be larger than a gradient of a low density part and a high density part in the target region, or for increasing a gradient of a middle brightness part in the target region to be higher than a gradient of a high brightness part and a low brightness part in the target region.

5. The apparatus of claim 1, wherein the gradation converting section converts a density of the non-target region into one density or converts a brightness of the non-target region into one brightness.

6. The apparatus of claim 1, wherein the gradation converting section converts the non-target region so as to form two density regions or two brightness regions by using an arbitrary threshold.

7. The apparatus of claim 1, wherein the gradation converting section converts the non-target region so as to make a density of a low density part higher or so as to make a brightness of a high brightness part lower.

8. The apparatus of claim 1, wherein the gradation converting section converts a density of an area other than the exposure field part in the medical image, into one density which is higher than a density of the non-target region, or converts a brightness of the area into one brightness which is lower than a density of the non-target region.

9. The apparatus of claim 1, further comprising:
a gradation conversion curve storing section for storing a plurality of gradation conversion curves; and
a gradation conversion curve selecting section for selecting a gradation conversion curve among the plurality of gradation conversion curves, to perform the gradation converting process corresponding to an output purpose,
wherein the gradation converting section performs the gradation converting process according to the selected gradation conversion curve.

10. The apparatus of claim 1, further comprising a gradation converting process condition changing section for changing a condition of the gradation converting process,
wherein the gradation converting section performs the gradation converting process under the changed condition of the gradation converting process.
